(19) United States
(12) Patent Application Publication
(10) Pub. No.: US 2013/0109560 A1
(43) Pub. Date: May 2, 2013

(54) PROCESS FOR REPROCESSING SPENT CATALYSTS

(71) Applicant: BASF SE, Ludwigshafen (DE)

(72) Inventors: Florina Corina Patcas, Ludwigshafen (DE); Yong Liu, Ludwigshafen (DE); Martin Dieterle, Ludwigshafen (DE)

(73) Assignee: BASF SE, Ludwigshafen (DE)

(21) Appl. No.: 13/665,219

(22) Filed: Oct. 31, 2012

Related U.S. Application Data
(60) Provisional application No. 61/553,266, filed on Oct. 31, 2011.

(51) Int. Cl. B01J 23/94; B01J 23/92

(52) U.S. Cl. 502/24; 502/27

(57) ABSTRACT

The invention relates to a process for reprocessing spent catalysts comprising rare earth metals, and to a process for producing a new styrene catalyst from a spent styrene catalyst.

The invention relates to a process for reprocessing spent catalysts comprising rare earth metals, and to a process for producing a new styrene catalyst from a spent styrene catalyst.

In view of significantly increased prices for rare earth compounds, there is a great interest in the selective recovery of rare earth compounds from spent catalysts. For the recovery of cerium compounds, one option is spent iron oxide-containing catalysts, as used for dehydrogenation of hydrocarbons, for example for dehydrogenation of isopentene to isopentadiene (isoprene) or of ethylbenzene to styrene. These generally have a cerium dioxide content in the range from 1 to 25% by weight, especially of 5 to 15% by weight. Such catalysts are described, for example, in EP 1 027 028 A1, DE 101 54 718 A1 and EP 0 894 528 B1.

A challenge in the processing of such spent catalysts is the composition thereof, which is complex in some cases. For instance, the catalysts comprise, as well as compounds of the rare earth metals, usually also compounds of numerous further elements, such as iron, potassium, molybdenum, magnesium, calcium, tungsten, titanium, copper, chromium, cobalt, nickel, vanadium and others.

For example, styrene catalysts consist principally of oxides of the elements iron and potassium, the iron being present predominantly as the trivalent oxide. In addition, styrene catalysts include various elements such as cerium, molybdenum, tungsten, vanadium, calcium, magnesium, etc. in oxidic form as promoters. The cerium is present in the styrene catalyst in the form of cerium dioxide CeO₂ in considerable amounts of about 1 to 25% by weight. During the dehydrogenation of ethylbenzene to styrene, the trivalent iron (Fe(III)) is partly reduced to divalent iron (Fe(II)). This forms magnetite Fe₃O₄. During utilization, styrene catalysts gradually lose activity. Several processes are responsible for the deactivation, for example potassium loss through vaporization, the irreversible formation and deposition of carbon or the increasing reduction of trivalent iron to divalent iron. After about 2 to 4 years, the deactivated styrene catalysts are deinstalled from the reactors and replaced by new catalysts. As a result, large amounts of spent deinstalled styrene catalysts arise globally every year, the reprocessing of which is of great economic interest due to the constantly rising costs of the doping components.

The prior art gives several descriptions of the reutilization of deinstalled styrene catalysts. In EP 1919614, WO 94/11104, CN 101306375, CN 101623643 and DD 268631, the deinstalled catalyst is optionally ground, calcined, possibly mixed with fresh raw materials (iron oxides, potassium compounds, promoters), extruded to shaped bodies and calcined again. This involves subjecting the deinstalled catalyst present therein to one to two additional calcining steps, usually at quite high temperatures of up to 1000° C. As a consequence, there is a reduction in the specific surface area of the catalyst compared to a catalyst which is produced exclusively from fresh raw materials. As known to those skilled in the art, a lower specific surface area in a catalyst leads to a smaller number of accessible active sites and consequently to a lower activity. The styrene catalysts produced by the route described from deinstalled catalysts therefore often have the disadvantage that their activity is lower compared to catalysts which have been produced exclusively from fresh raw materials.

WO 2007/009927 A1 describes a process for producing dehydrogenation catalysts using secondary raw material which is obtained by processing spent catalysts. In this process, there is no chemical separation of the catalyst constituents into compounds of the individual metals. Instead, 10 to 70% by weight of a calcined and ground spent catalyst comprising iron oxide is mixed with 30 to 90% by weight of a catalyst material comprising fresh iron oxide.

KR2002-0093455 describes a process for obtaining cerium dioxide from spent dehydrogenation catalysts which are used for preparation of styrene from ethylbenzene. This involves moist grinding of the spent catalyst, for example in a ball mill, down to a particle size of 0.1 to 5 μm. After removal of the ground catalyst by filtration and addition of acid to the solids, a slurry is prepared with a pH of 0.5 to 3.0, which is filtered once again. The solid residue is admixed with water and, with addition of organic dispersants, dispersed using ultrasound, whereupon two phases form, the intention being that the lower phase comprises iron oxide (magnetite) and the upper phase cerium dioxide. The very fine grinding of the spent catalyst is costly and inconvenient; the organic dispersants used can pollute the wastewater.

It is an object of the present invention to provide a process for reprocessing spent cerium-containing catalysts, which allows complete removal and recovery of the cerium present in the spent catalyst. It was a further object of the invention to produce a styrene catalyst using the cerium recovered, the specific surface area of which should be at least equal to the surface area of the deinstalled catalyst.

This object is achieved by a process for reprocessing spent cerium-containing catalysts, in which the cerium present in the catalyst is converted quantitatively to insoluble cerium dioxide and then the remaining constituents of the catalyst are dissolved.

The invention thus provides a process for reprocessing spent cerium-containing catalysts, comprising the steps of:
(i) heating the catalyst in an oxygen-comprising atmosphere,
(ii) treating the catalyst with an aqueous acid to obtain an aqueous solution comprising the soluble constituents of the catalyst and a solid residue comprising cerium dioxide,
(iii) recovering the solids comprising cerium dioxide by separating the solid residue from the aqueous solution.

In general, spent cerium-containing catalysts which are reprocessed by the process according to the invention comprise compounds at least of the following metals:
iron, corresponding to 40 to 90% by weight of Fe₂O₃,
potassium, corresponding to 1 to 40% by weight of K₂O, and
cerium, corresponding to 1 to 25% by weight of CeO₂, especially 5 to 15% by weight of CeO₂.

In a preferred embodiment, the catalysts additionally comprise compounds of
calcium, corresponding to 0 to 10% by weight of CaO,
molybdenum, corresponding to 0.1 to 10% by weight of MoO₃, and/or
magnesium, corresponding to 0 to 10% by weight of MgO.

In addition, the catalysts may comprise small amounts of further elements present as typical impurities in the iron oxides used as primary starting materials.

In one embodiment of the process according to the invention, the catalysts comprise oxides of iron, potassium, and cerium. In a further embodiment, the catalysts comprise oxides of iron, potassium, molybdenum, cerium and calcium. In a further embodiment, the catalysts comprise oxides of iron, potassium, molybdenum, cerium, calcium and magnesium.

In the first step (i) of the process according to the invention, the deinstalled catalyst is heated in an oxygenous atmosphere, with the aim of oxidizing the magnetite present in the catalyst to hematite, i.e. all Fe(II) cations should be converted to Fe(III) cations. In addition, any Ce(III) compounds present should be converted to CeO₂, and carbon and organic residues present in the deinstalled catalyst should be oxidatively removed. This calcination step (i) can take place at temperatures between 400° C. and 1100° C., preferably between 500 and 1000° C., more preferably between 600 and 900° C. The catalyst can be calcined in a stationary manner on metal sheets in a muffle furnace, or in a rotary tube furnace or in a fluidized bed.

The oxygenous gas used is preferably air. It is also possible to use lean air.

Prior to the calcination, the deinstalled catalyst can optionally be washed with water at pH values of 7 to 12. This removes the potassium compounds from the catalyst, as a result of which the acid for the later neutralization of the potassium is saved and the typical variation in the potassium content and the amount of bound anions (for example chloride, sulfate, nitrate) in the deinstalled catalyst is reduced. Likewise prior to the calcination, the deinstalled catalyst can be mechanically comminuted, for instance by grinding or crushing. This increases the surface area and improves access of oxygen to the metal atoms. The lower particle size is also favorable for the subsequent dissolution stage. Of course, the mechanical comminution of the catalyst may also follow the heating. In a preferred embodiment of the invention, the deinstalled catalyst is comminuted in such a way that the mean particle diameter is in the range from 1 to 700 μm, preferably 5 to 500 μm, especially from 10 to 200 μm.

In the second step (ii) of the process according to the invention, the calcined deinstalled catalyst is treated with an aqueous acid, for example an inorganic acid (e.g. hydrochloric, sulfuric, nitric acid) or organic acid (e.g. acetic acid, formic acid, ascorbic acid etc.) or a mixture of two or more acids, at pH values of <0.5. This converts all metal cations except Ce⁴⁺ to salts and they go into solution. Cerium dioxide is insoluble in the aqueous acid under these conditions, in the absence of any reducing agents. The concentration of the aqueous acid may, for example, be from 5 to 80% by weight, preferably from 10 to 70% by weight, more preferably from 10 to 50% by weight. The pH of the acid solution is −2 to 0.5, preferably from −1.5 to 0.4, more preferably from −1.1 to 0. The pH of the acidic solution can rise with increasing dissolution of constituents of the deinstalled catalyst.

The stoichiometric ratio of acid to catalyst may be from 10 to 200%, preferably between 20 and 150%, more preferably between 50 and 120%. The stoichiometric ratio is understood to mean the theoretical ratio of acid to the metal ions to be dissolved in the catalyst, which is required for formation of stable metal salts at the treatment temperature.

To accelerate the dissolution, the acid solution can be heated under reflux at a temperature of 10° C. up to 120° C. Preference is given to a temperature between 20° C. and 80° C., more preferably between 20° C. and 60° C. The dissolution process is performed with a period between 0.5 h and 24 h. This process step produces a suspension comprising undissolved CeO₂ particles in a solution of dissolved Fe³⁺ salts and salts of the other promoter metals.

In the course of dissolution, the carbonates present in the deinstalled catalyst can form carbon dioxide. In order to control foam formation, the dissolution can be performed in several ways. For example, the deinstalled catalyst can be initially charged in demineralized water and concentrated acid can be added stepwise until the desired acid:catalyst ratio is attained. Alternatively, the full amount of acid can be initially charged in demineralized water and the catalyst can be added in portions.

The weight ratio between the deinstalled catalyst solids and the amount of acidic liquid is kept between 1:1 and 1:20, in order to enable good dispersion and mixing of the solids. Preference is given to a ratio between 1:2 and 1:15, more preferably between 1:5 and 1:10.

In the third step (iii) of the process according to the invention, the suspension from step (ii) is subjected to a solid-liquid separation such as decantation, filtration, centrifugation etc. This separates the undissolved cerium dioxide from the acidic salt solution. Thereafter, the cerium dioxide is washed repeatedly with a dilute acid solution (preferably with the same acid as in the dissolution) and then repeatedly with water in order to reduce the content of adsorbed anions. Subsequently, the moist cerium dioxide is dried at 60 to 120° C.

By virtue of the selective dissolution of all catalyst components except CeO₂ in the process according to the invention with subsequent solid/liquid separation, the separation of the cerium from the other catalyst components is very efficient and allows a high purity of the recycled cerium.

The cerium dioxide obtained can be used as such, for example as a polishing medium, or be converted to other cerium compounds by known processes. For example, the cerium dioxide can be digested with concentrated (90 to 100% by weight) sulfuric acid at temperatures of 100 to 120° C. and converted to cerium(IV) sulfate. In addition, cerium(IV) oxide can be converted with a dilute acid such as hydrochloric, sulfuric or nitric acid, using a reducing agent such as hydrogen peroxide, formic acid, oxalic acid, hydrazine or other reducing agents customary in industry, to the soluble Ce(III) salt of the respective acid. Subsequently, the cerium salts can be precipitated as the carbonate or hydroxide. It is thus possible to convert the recycled cerium to virtually all common cerium compounds.

The acidic salt solution of the other catalyst constituents can be processed further in a separate step as required. Since it consists principally of dissolved iron salts, it can be used, for example, as a flocculant for water treatment.

The acidic salt solution of the other catalyst constituents and the recycled cerium dioxide can also be used to produce a new styrene catalyst. For this purpose, the metal cations present in the solution can be isolated in the form of solid compounds, for instance as oxides, oxide hydroxides, hydroxides or carbonates, for example by spray drying or precipitation and optional oxidative calcination. After analysis, any missing constituents and promoters are added, for example potassium, the recycled cerium, etc., in the form of oxides, hydroxides, carbonates or other compounds, and the solids mixture is processed by standard methods for shaping (kneading, extruding, drying) and calcined to give a new catalyst.

The invention thus further provides a process for producing a new styrene catalyst from a spent styrene catalyst, comprising the steps of
(i) heating the spent catalyst in an oxygen-comprising atmosphere,
(ii) treating the catalyst with an aqueous acid to obtain an aqueous solution comprising the soluble constituents of the catalyst and a solid residue comprising cerium dioxide,
(iii) recovering the solids comprising cerium dioxide by separating the solid residue from the aqueous solution,
(iv) isolating the metal cations present in the aqueous solution in the form of solid compounds,
(v) adding any missing constituents after analysis, including the recycled cerium,
(vi) shaping and calcining the solid mixture obtained in step (v).

In a preferred embodiment of the invention, the new catalyst comprises compounds of the following elements (contents based on the element oxides): iron—50 to 90% by weight, potassium—1 to 30% by weight, cerium—1 to 20% by weight, molybdenum—0 to 10% by weight, tungsten—0 to 10% by weight, vanadium—0 to 10% by weight, magnesium—0 to 10% by weight, calcium—0 to 10% by weight and 0 to 10% by weight of oxides of other metals such as Cr, Co, Ni, Cu, Zn, Ag, Pt, Pd, Al, La or other promoters known in the literature, where the contents add up to 100% by weight. In addition, it is possible to add assistants to the catalyst precursor, in order to improve the processibility, the mechanical strength and the pore morphology of the catalyst. For example, it is possible to add potato starch, graphite, cellulose, alginates, stearic acid, and also portland cement, kaolin, montmorillonite or waterglass. After the shaping, the possibly moist shaped bodies are dried at temperatures of 50° C. to 500° C. Preference is given to using temperatures of 80 to 350° C. The drying may take place, for example, in drying cabinets on metal sheets, in drying drums or on belt driers. The subsequent calcining of the catalyst is performed preferably in a rotary tube furnace at temperatures between 500° C. and 1100° C., preferably between 700 and 1000° C.

The new catalyst obtained by the process according to the invention generally has a greater specific surface area and a higher activity than the old deinstalled catalyst.

The new catalyst obtained from recycled deinstalled catalyst is used in the dehydrogenation of ethylbenzene to styrene with water vapor in exactly the same way as a catalyst produced only from new raw materials.

### EXAMPLES

### Example 1 (Comparative Example)

This comparative example describes the treatment of a deinstalled catalyst with a concentrated solution of an inorganic acid when the deinstalled catalyst has not been calcined, i.e. the iron is present largely in magnetite form. The deinstalled catalyst from a styrene reactor, after a run time of about 3 years, had a composition (in % by weight as metals) Fe: 48.0; K: 8.0; Ce: 7.2; Mg: 1.1; Ca: 1.5; residual content of other promoters, oxygen and carbon. The phase composition of the deinstalled catalyst, determined by XRD analysis (Cu K-alpha cathode), exhibits the following crystallographic phases: magnetite Fe₃O₄, cerianite CeO₂, potassium molybdate K₂MoO₄, potassium carbonate hydrate K₂CO₃×1.5 H₂O, kalicinite KHCO₃.

675 g of ground deinstalled styrene catalyst were treated with 3820 g of 37% hydrochloric acid (pH=−1.1) as follows. A flask is initially charged with the acid and preheated to 60° C. Then the catalyst is added in portions, forming foam. After addition of the total amount of catalyst, the mixture was stirred at 60° C. for 24 h. At the end, all of the catalyst, with the exception of a few unquantifiable black carbon traces, is in dissolved form.

### Example 2

89 g of deinstalled styrene catalyst (composition as described in example 1) were ground and calcined in air at 900° C. for 6 h. Then the calcined catalyst is added in portions to an initial charge of 503 g of 37% (pH=−1.1) hydrochloric acid at room temperature while stirring. After 3 h, everything except a white residue had dissolved. The white residue was filtered off, washed twice with 200 ml each time of 5% hydrochloric acid and twice with 200 ml each time of demineralized water, and then dried at 120° C. for 2 h. 7.8 g of solids were obtained. Based on the theoretical amount of Ce in the deinstalled catalyst, this corresponds to a yield of 100%. The resulting solids comprised 98% by weight of CeO₂.

### Example 3

100 g of deinstalled styrene catalyst (composition as described in example 1) were ground and calcined in air at 900° C. for 6 h. Then the calcined catalyst is added in portions to an initial charge of 566 g of 37% (pH=−1.1) hydrochloric acid at room temperature while stirring. After 3 h, everything except a white residue had dissolved. The white residue was filtered off and washed with 500 ml of demineralized water, then dried at 120° C. for 2 h. 9 g of solids were obtained. Based on the theoretical amount of Ce in the deinstalled catalyst, this corresponds to a yield of 100%. The resulting solids comprised 96% by weight of CeO₂; the XRD analysis of the solids showed only the reflections of the CeO₂ phase.

### Example 4

1 g of the solids obtained in example 3 were mixed with 5 g of HNO₃ solution (40% by weight) and 5 g of H₂O₂ solution (30% by weight) in a glass flask and kept with occasional stirring for 1 week. At the end, 10 g of a clear liquid with a cerium content of 8.2% by weight were obtained. This corresponds to a dissolution yield of the cerium dioxide of 100%.

### Example 5

5 g of the solids obtained in example 3 were admixed with 10 g of concentrated 97% sulfuric acid at 120° C. and stirred for 2 h. Thereafter, the mixture is added to 250 ml of demineralized water and the solid residue is filtered off. The cerium content of the filtered solution was 1.1% by weight; based on the total filtrate mass of 265 g, this corresponds to an amount of dissolved cerium dioxide of 3.58 g or a dissolution yield of 71%.

### Example 6

50 g of cerium sulfate solution from example 5 (corresponding to 0.55 g of dissolved Ce) were precipitated with a solution of 20 g of ammonium bicarbonate in 100 ml demineralized water up to a pH of 7.9. The cerium carbonate solids were removed by filtration and centrifugation; 3 g of moist cerium carbonate were obtained. The 160 ml of filtrate include 0.1% Ce, i.e. 0.16 g of Ce was not precipitated. The cerium carbonate yield in the precipitation with ammonium bicarbonate is thus 71%.

### Example 7

50 g of cerium sulfate solution from example 5 (corresponding to 0.55 g of dissolved Ce) were precipitated with 25% by weight ammonium hydroxide solution up to a pH of 8.6. The cerium hydroxide solids were removed by centrifugation. The cerium analysis of the filtrate gave 10 ppm; the cerium hydroxide yield in the precipitation with ammonium hydroxide was thus virtually 100%.

1.-11. (canceled)

12. A process for reprocessing spent cerium-containing catalysts, comprising the steps of:
(i) heating the catalyst in an oxygen-comprising atmosphere,
(ii) treating the catalyst with an aqueous acid to obtain an aqueous solution comprising the soluble constituents of the catalyst and a solid residue comprising cerium dioxide,
(iii) recovering the solids comprising cerium dioxide by separating the solid residue from the aqueous solution.

13. The process according to claim 12, wherein the spent cerium-containing catalyst comprises at least compounds of the metals iron, corresponding to 40 to 90% by weight of Fe2O3, potassium, corresponding to 1 to 40% by weight of K2O and cerium, corresponding to 1 to 25% by weight of CeO2.

14. The process according to claim 13, wherein the spent cerium-containing catalyst additionally comprises compounds of calcium, corresponding to 0 to 10% by weight of CaO, molybdenum, corresponding to 0.1 to 10% by weight of MoO3, and/or magnesium, corresponding to 0 to 10% by weight of MgO.

15. The process according to claim 12, wherein the spent cerium-containing catalyst prior to heating is washed with water and/or mechanically comminuted.

16. The process according to claim 12, wherein an aqueous acid with a pH of <0.5 is used.

17. The process according to claim 12, wherein the weight ratio between the catalyst and the aqueous acid is in the range from 1:1 to 1:20.

18. The process according to claim 12, wherein the cerium dioxide obtained is possibly dissolved using a reducing agent and converted to other cerium compounds.

19. The use of the aqueous solution obtained in the process according to claim 12 as a flocculant for water treatment.

20. A process for producing a new styrene catalyst from a spent styrene catalyst, comprising the steps of
(i) heating the spent catalyst in an oxygen-comprising atmosphere,
(ii) treating the catalyst with an aqueous acid to obtain an aqueous solution comprising the soluble constituents of the catalyst and a solid residue comprising cerium dioxide,
(iii) recovering the solids comprising cerium dioxide by separating the solid residue from the aqueous solution,
(iv) isolating the metal cations present in the aqueous solution in the form of solid compounds,
(v) adding any missing constituents after analysis, including the recycled cerium,
(vi) shaping and calcining the solid mixture obtained in step (v).

21. The process according to claim 20, wherein the new styrene catalyst comprises compounds of the following elements (contents based on the element oxides): iron—50 to 90% by weight, potassium—1 to 30% by weight, cerium—1 to 20% by weight, molybdenum—0 to 10% by weight, tungsten—0 to 10% by weight, vanadium—0 to 10% by weight, magnesium—0 to 10% by weight, calcium—0 to 10% by weight and 0 to 10% by weight of oxides of other metals, where the contents add up to 100% by weight.

22. The process according to claim 20, wherein the new catalyst has a greater specific surface area than the spent catalyst.
